(19) United States
(12) Patent Application Publication
(10) Pub. No.: US 2013/0246255 A1
(43) Pub. Date: Sep. 19, 2013

(54) Systems and Methods for Compensating a Party in a Barter Transaction

(71) Applicant: BARTERBENDER, LLC, Corona, CA (US)

(72) Inventor: Robert Pernice, Corona, CA (US)

(73) Assignee: BARTERBENDER, LLC, Corona, CA (US)

(21) Appl. No.: 13/795,648

(22) Filed: Mar. 12, 2013

Related U.S. Application Data
(60) Provisional application No. 61/610,055, filed on Mar. 13, 2012.

(51) Int. Cl. G06Q 20/08

(52) U.S. Cl. CPC G06Q 20/085
USPC 705/39

(57) ABSTRACT

A barter transaction system facilitates a barter transaction by determining a monetary compensation amount to compensate a party in a barter transaction when another party in the barter transaction fails to fulfill his/her obligation in the transaction. The barter transaction involves an exchange of a first non-monetary item from a first user with a second non-monetary item from a second user. The barter transaction system determines a compensation amount for compensating the first user based on a monetary value that the second user perceives of the second item. The perceived value is given by the second user and assigned to the second non-monetary item. The barter transaction system also allows the first and second user to negotiate the perceived value until both users agree to the barter transaction.

This application claims the benefit of U.S. provisional application No. 61/610,055, filed Mar. 13, 2012. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is a system for facilitating barter transactions.

### BACKGROUND

The disclosed technology generally relates to systems and methods for facilitating a barter transaction by protecting a first party to the transaction from value loss in the event that the second party fails to fulfill one or more obligations of the transaction.

While many systems exist to compensate victims of fraudulent or bad faith monetary transactions by, for example, holding a determined amount of money in escrow, there remains a need for improved platforms that provide similar protections for transactions involving the exchange of non-monetary goods and services, such as a barter transaction.

A barter transaction is defined herein as a transaction that involves an exchange of at least one non-monetary item with another non-monetary item. An example of a barter transaction would be an exchange of a book with a pen. A barter transaction can also involve monies in addition to non-monetary items. For example, party A can exchange a book for a pen in addition to an amount of money.

There are several online payment service providers today including PayPal®, Google Wallet®, Amazon Payments® and Stripe® that provide systems that facilitate monetary transactions. (Typically an exchange of non-monetary goods or services for money.) These services provide merchants and sellers with a means of accepting electronic payments by a variety of payment methods including credit card, bank transfer, bank-based payments such as direct debit, and real-time bank transfer based on online banking Typically, the payment service provider maintains partnerships and connections with multiple acquiring banks, card and payment networks. In most cases, the service provider fully manages these technical connections, relationships with the external networks, and bank accounts. Thus, the primary advantage offered to the online merchant is that the merchant can be less dependent on financial institutions and can be free from the task of establishing these connections, directly. Additionally, the online merchant does not need to worry about independently developing the software and security infrastructures that would be necessary to accept electronic payments.

More relevant, however, online payment services typically offer risk management mechanisms and fraud protection, and have allowed for consumers and merchants to be comfortable with the buying and selling of goods over the internet. The systems, for one, typically hide sensitive, financial information such as credit card numbers from the opposite party to a transaction. The systems may also have mechanisms in place to hold money in escrow contingent on certain terms of a transaction being satisfied. Additionally, many of these online payment services maintain strong user assurance and insurance programs. The online payment service providers, thus, have remained the most widely used solutions for protecting parties to monetary transactions from fraud or breach. In all cases, however, the service providers are able to assure just compensation to each party of the transaction because such transactions always involve a known, definitive monetary value.

This means that such systems have the known limitation of not being effective in non-monetary barter transactions in which no definitive monetary value is being exchanged. For example, in the sale of a book for $10, there is a known, definitive monetary value of $10 associated with the transaction. In the event that the seller fails to deliver the book, it is determinable that the buyer suffered a loss of $10, and should be compensated accordingly. Today's online payment services could certainly provide a means of protecting the buyer in such instances.

To the contrary, in the barter exchange of a book for a pen, no such definitive monetary value can be associated with the exchange. Each party may value each item differently, there may be more than one possible “market value” for each item, and the values can fluctuate based on a number of variables in the marketplace. In the event of a breach of the transaction, there is great challenge in calculating the loss each party suffered and, thus, the compensation, trade value, good, or service that the injured party might be owed.

Others have put forth effort towards developing systems to protect against fraud and breach in non-monetary barter transactions. Unfortunately, these known systems have several limitations.

For example, U.S. Pat. No. 7,925,541 to Bocheck titled “Method, System, and Medium for Conducting Barter Transactions,” issued Apr. 12, 2011, discusses a communications network allowing for bartering between trade parties each having one or more items available for barter. To protect against fraudulent behavior, the Bocheck system disallows trade parties from committing the same trade item to multiple potential transactions simultaneously. By locking an item that is being offered for trade, the Bocheck system aims to reduce the likelihood of a party committing to more than one transaction and thus being forced to breach one or more of such transactions. Bocheck, however, does not teach any mechanisms for redressing an injured trade party to a transaction after the opposite party has already failed to deliver a trade item.

One contemplated method of redressing an injured party to a barter transaction would be to compensate the party with a monetary value equivalent to the economic loss the party suffered. Several methodologies exist for assigning monetary value to non-monetary goods and services. For example, U.S. patent application US 2012/0226528 A1 to Warda entitled “Result-Based Payment Method and System,” published Sep. 6, 2012, contemplates a compensation system in which a non-monetary, intangible service, such as education or coaching, can be assigned a monetary value based on measured results obtained during a process. For example, a student could be charged for an online educational course (intangible service) based on the student's progress in achieving set educational milestones. Warda does not discuss applying such methodologies to calculating the value of a service at the point of sale or to calculating values of non-service goods. Warda also fails to incorporate factors outside of measured results-based factors in its value determining methodologies. Alternatively, U.S. patent application US 2006/0080226 to Pickering entitled “System and Method for Swapping of Tangible Items,” issued Aug. 23, 2011, discusses assigning a credit value to tangible items, such that the credit value may be used in a marketplace to purchase other tangible items. Unfortunately, Pickering fails to provide redress in the event that the injured party requires compensation that can be used outside of the marketplace.

These and all other extrinsic materials discussed herein are incorporated by reference in their entirety. Where a definition or use of a term in an incorporated reference is inconsistent or contrary to the definition of that term provided herein, the definition of that term provided herein applies and the definition of that term in the reference does not apply.

Even though the above references are useful for their intended purposes, they do not address circumstances in which a barter transaction involves the exchange of non-monetary items that lack a known or definitive monetary value. Thus, there is a need to provide improved systems and methods for protecting parties to a non-monetary barter transaction from value loss in the event that one or more parties fail to fulfill an obligation of the transaction.

### SUMMARY OF THE INVENTION

The inventive subject matter provides apparatus, systems, and methods for facilitating a barter transaction. Specifically, the apparatus, systems, and methods of the inventive subject matter determine a monetary amount to compensate a party in a barter transaction in the event that another party in the barter transaction fails to fulfill his/her obligation in the transaction. A barter transaction is defined herein as a transaction that involves an exchange of at least one non-monetary item with another non-monetary item. The non-monetary item can be a good (e.g., a pen, a computer, etc.) or service (e.g., lawn mowing service, accounting service, etc.). An example of a bartering transaction would be an exchange between a book and a pen. A barter transaction can also involve monies in addition to non-monetary items. For example, one can exchange a non-monetary item along with an amount of money for another non-monetary item.

According to one aspect of the invention, a barter transaction system facilitates a barter transaction by determining a compensation amount for one party in the transaction when the other party fails to fulfill the other party's obligation in the transaction. The barter transaction system includes a bartering database and a barter transaction engine that is coupled to the bartering database. The bartering database stores bartering data associated with a first set of bartering items that belong to a first user and bartering data associated with a second set of bartering items that belong to a second user.

The barter transaction engine in some embodiments is configured to receive a barter transaction request from a user. The barter transaction request comprises an agreement representing an obligation of the first user to exchange a first bartering lot selected from the first set of bartering items for a second bartering lot selected from the second set of bartering items. The first bartering lot can comprise any non-monetary items such as a product or a service.

The barter transaction engine is also configured to determine a compensation amount that compensates the second user in an event that the first user fails to fulfill the obligation of the barter transaction. The barter transaction engine then configures an output device to present the compensation amount to the first user.

In some embodiments, the compensation amount can be any type of currency, including a currency of a sovereign jurisdiction or a currency of a non-sovereign community (e.g., a currency of a virtual community).

The barter transaction engine of some embodiments also has access to a fund account owned by the first user. In some of these embodiments, the barter transaction engine is further configured to withhold (or instruct an institution to withhold) the compensation amount from the fund account owned by the first user.

The compensation amount can be determined in different ways. In one approach, the barter transaction engine is configured to determine the compensation amount based on a first perceived value perceived by the first user of the first bartering lot. In these embodiments, the barter transaction engine receives the first perceived value from the first user and stores the first perceived value in the database. The barter transaction engine also allows the first user to update the stored perceived value before execution of the barter transaction.

In some embodiments, the compensation amount is also based on a perceived value perceived by the second user of the first bartering lot, such that the compensation amount is a function of the first perceived value and the second perceived value. In some of these embodiments, the barter transaction engine provides an interface that allows the first and second users to negotiate an agreeable value for the first bartering lot.

In some embodiments, the barter transaction engine is further configured to validate the first perceived value.

In some embodiments, the barter transaction engine is configured to query the database for a bartering item with an associated perceived value that is within a predetermined deviation from the first perceived value. The barter transaction engine can also query the database for several bartering items having an accumulated perceived value within the pre-determined deviation from the first perceived value. The barter transaction will then present the queried bartering item(s) to the first user via an output device.

In another aspect of the invention, a method is provided to facilitate a barter transaction. The method includes the step of providing access to a bartering database that stores bartering data associated with a first set of bartering items that belong to a first user, and bartering data associated with a second set of bartering items that belong to a second user. The method includes a step of providing access to a barter transaction engine that is communicatively coupled to the bartering database.

The method includes the step of receiving, by the barter transaction engine, a barter transaction request that comprises an agreement representing an obligation of the first user to exchange a first bartering lot selected from the first set of bartering items for a second bartering lot selected from the second set of bartering items. The method includes the step of determining, by the barter transaction engine, a compensation amount that compensates the second user in an event that the first user fails to fulfill the obligation of the barter transaction. The method includes the step of configuring, by the barter transaction engine, an output device to present the compensation amount to the first user.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of the barter transaction system of the current inventive subject matter.

FIG. 2 illustrates different attributes of a barter item object.

FIG. 3 illustrates an example bartering scenario between two users using the barter transaction system of some embodiments.

### DETAILED DESCRIPTION

It should be noted that any language directed to a computer should be read to include any suitable combination of computing devices, including servers, interfaces, systems, databases, agents, peers, engines, modules, controllers, or other types of computing devices operating individually or collectively. One should appreciate the computing devices comprise a processor configured to execute software instructions stored on a tangible, non-transitory computer readable storage medium (e.g., hard drive, solid state drive, RAM, flash, ROM, etc.). The software instructions preferably configure the computing device to provide the roles, responsibilities, or other functionality as discussed below with respect to the disclosed apparatus. In especially preferred embodiments, the various servers, systems, databases, or interfaces exchange data using standardized protocols or algorithms, possibly based on HTTP, HTTPS, AES, public-private key exchanges, web service APIs, known financial transaction protocols, or other electronic information exchanging methods. Data exchanges preferably are conducted over a packet-switched network, the Internet, LAN, WAN, VPN, or other type of packet switched network.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

The inventive subject matter provides apparatus, systems, and methods for facilitating a barter transaction. Specifically, the apparatus, systems, and methods of the inventive subject matter determine a monetary amount to compensate a party in a barter transaction when another party in the barter transaction fails to fulfill his/her obligation in the transaction. A barter transaction is defined herein as a transaction that involves an exchange of at least one non-monetary item with another non-monetary item. The non-monetary item can be a product (e.g., a pen, a computer, etc.) or service (e.g., lawn mowing service, accounting service, etc.). An example of a bartering transaction would be an exchange between a book and a pen. A barter transaction can also involve monies in addition to non-monetary items. For example, one can exchange a non-monetary item along with an amount of money for another non-monetary item.

While it is relatively easy to determine such a compensation amount in a monetary transaction (e.g., buying and selling items), it is often difficult to determine a compensation amount in a barter transaction because many of the items being traded in a barter transaction are used items or their true values are not otherwise readily available. In addition, an item (such as an heirloom or collectible) may have different perceived values to different people.

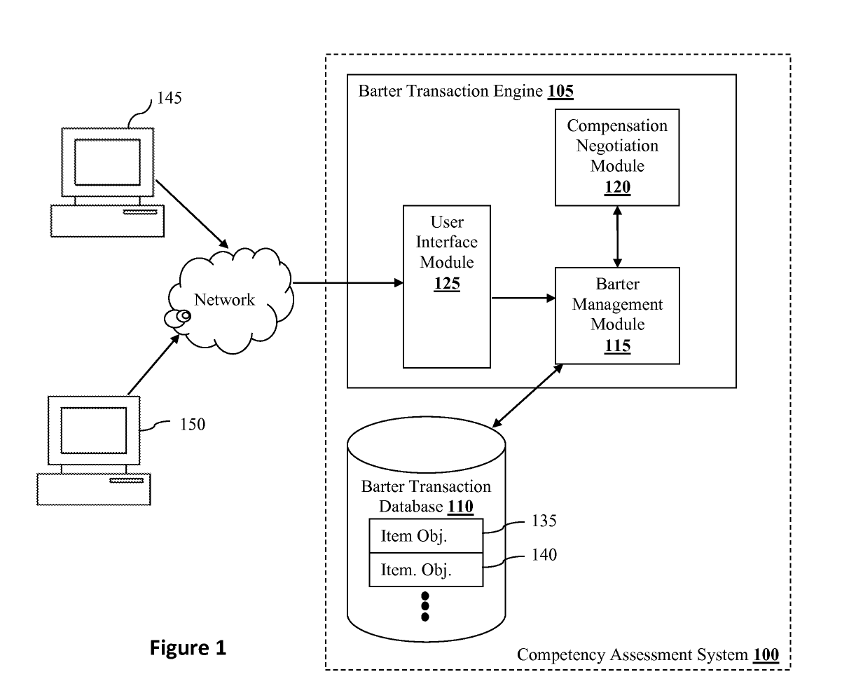

According to one aspect of the invention, a barter transaction system protects a first party to a barter transaction from potential financial losses by determining a compensation amount for the first party. The compensation amount is for compensating the first party in the event that a second party to the barter transaction fails to fulfill his/her obligation in the transaction. FIG. 1 illustrates a schematic of such a barter transaction system 100. In FIG. 1, the barter transaction includes a barter transaction database 110 and a barter transaction engine 105 that is communicatively coupled to the barter transaction database 110. The barter transaction database 110 of some embodiments is implemented in a non-transitory permanent data storage such as a hard drive, a flash memory, etc. In some embodiments, the database 110 can be a file system, database management system, a document, a table, etc. In some embodiments, the database 110 stores barter item objects (such as barter item objects 135 and 140) that are associated with non-monetary items that users have made available for potential barter transactions.

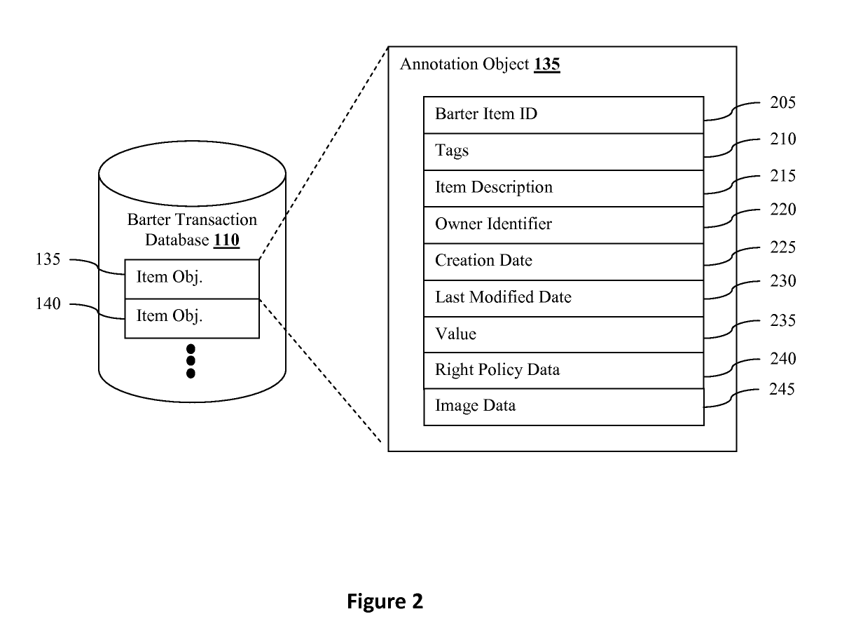

Each barter item object represents a specific non-monetary item, and includes attributes that store information related to the non-monetary item. FIG. 2 illustrates an example barter item object in more detail. Specifically, FIG. 2 shows barter item object 135 and barter item object 140 that are stored in the barter transaction database 110. FIG. 2 also illustrates a set of example attributes of the barter item object 135. As shown, the barter item object 135 includes a barter item ID 205, a set of tags 210, an item description 215, an owner identifier 220, a create date 225, a last modified date 230, a value 235, right policy data 240, and image data 245.

The barter item ID 205 is used to uniquely identify an item that is available for a barter transaction. The barter item ID 205 can be used by the barter transaction engine 105 for identifying and retrieving the barter item object 135 from the barter transaction database 110.

The set of tags 210 comprises tags that the owner of the item created so that other users can search for the item 135 using one or more of those tags via the barter transaction engine 105. For example, when the owner of a novel by James Patterson entitled “Alex Cross, Run” makes the novel available for potential barter transaction, the owner can include tags such as “James Patterson”, “book”, “novel”, “Alex Cross, Run”, etc.

The item description 215 includes a brief description of the item. In some embodiments, the item description also provides a condition of the item (e.g., new, slightly used, like new, etc.).

The owner identifier 220 identifies the owner of the item. The identifier can be a name, a number (e.g., social security number), or a string of characters. The barter transaction system 100 of some embodiments can include another database that stores information of different users of the systems. The system 100 can then retrieve the owner's information by querying the user database using the owner identifier.

The creation date 225 and the last modified date 230 indicate the date that the owner made the item available for potential barter transaction, and the date that the owner last modified the information about the item, respectively.

The value 235 is a monetary value that the owner assigned to the item. Since items that are made available for barter transactions can be items without a definite market value (e.g., second-hand used products, heirlooms, collectibles etc.). The value 235 assigned to the item represents the owner's perceived value of the item, and can be updated by the owner at any time until a barter transaction that involves the item is executed. In some embodiments, the barter transaction system 100 uses the value 235 to determine a compensation amount for compensating the receiver of the item in a barter transaction in the event that the item's owner fails to deliver his/her obligation of the transaction with respect to the item.

Rights policy data 240 includes information that indicates which users have access to view the item. In some embodiments, it can include a list of users who have access to the barter item object (i.e., a white list), or a list of users who are excluded from accessing the barter item object (i.e., a black list). In other embodiments, it can indicate a specific access level (e.g., top security, public, group, etc.) so that only users who have clearance of a specific access level can access the barter item object.

Image data 245 includes data for one or more images of the item. The owner of the item can upload these images of the item when the owner makes the item available for potential barter transactions.

Referring back to FIG. 1, the barter transaction engine 105 includes a barter management module 115, a compensation negotiation module 120, and a user interface module 125. The user interface module 125 communicates with computing devices 145 and 150 over a network (e.g., a local area network, the Internet, etc.). The user interface module 125 is configured to provide a user interface (e.g., web interface) through which the users can interact with the barter transaction system 100. Users behind the computing devices 145 and 150 can make new items to be available for potential barter transactions, negotiate a barter transaction with fellow users of the system 100, and agree to barter transactions by providing inputs to the barter transaction engine 105 via the user interface module 125.

When the barter transaction engine 105 receives an event for adding a new item (e.g., user selects to add a new barter item via the user interface), the barter management module 115 instantiates a new barter item object. The user interface module 125 can also prompt the user for information about the item to be added as a barter item through the user interface. Specifically, the user interface module 125 will prompt the user to provide a description, a condition, tags, images, and also a perceived value of the item.

In some embodiments, the barter transaction system 100 has a set of pre-defined tags that is used to describe a variety of items (e.g., book, CD, audio system, electronics, etc.). When prompting the user for tags, the user interface module 125 can provide a list of tags from which the user can choose.

In some embodiments, the perceived value of the item can be a monetary value that the user (owner of the item) believes (or perceives) that the item in its current condition is worth. The perceived value can also be a market value if the market value is attainable, through third-party sources (e.g., if the item in its current condition is being sold elsewhere such as eBay® or Amazon.com®, etc.). The perceived value can also be the value of another item that the owner would like to receive in exchange through a barter transaction. The value can be in any currencies, including currency of a sovereign jurisdiction (e.g., United States Dollars, etc.) or a currency of a non-sovereign community (e.g., a currency used in a virtual community, etc.).

In some embodiments, the barter transaction engine 105 validates the perceived value provided by the user through an independent source (e.g., eBay®, Amazon.com®, etc.). The barter transaction engine 105 can notify the user when the perceived value is drastically different from the value that the engine 105 obtains through an independent source. At that time, the user can choose to correct the perceived value of the item.

Once received, the barter management module 115 inserts the information within the newly created barter item object, and stores the object in the barter transaction database 110.

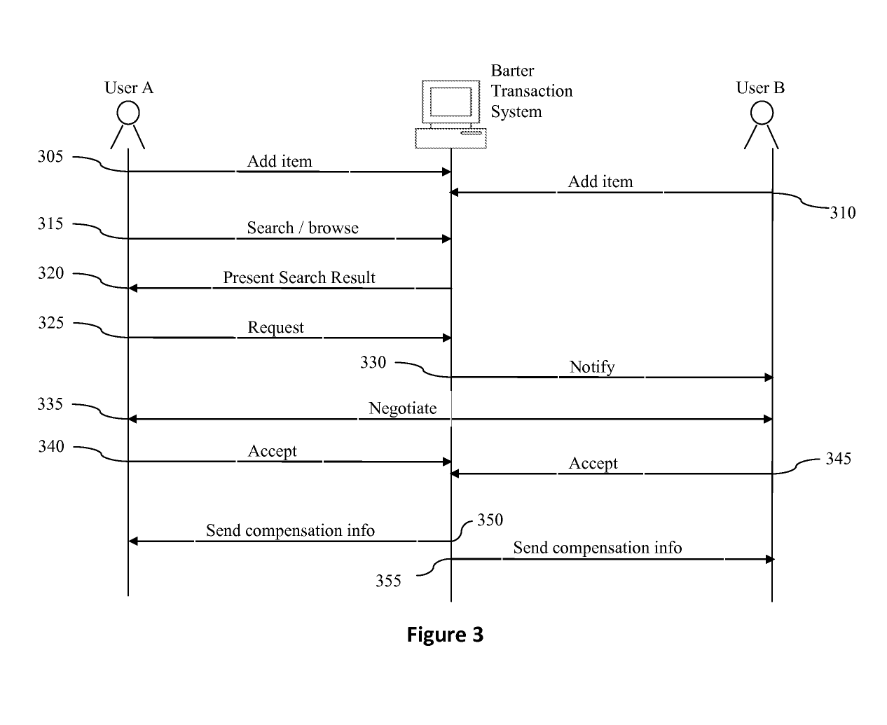

In addition to creating new barter item objects, the barter transaction system 100 provides many more functionalities to users for facilitating barter transactions. FIG. 3 illustrates possible functionalities that the barter transaction system 100 can provide to users through an example bartering scenario between user A and user B.

In FIG. 3, User A is looking to exchange a non-monetary item with another non-monetary item (i.e., bartering). Both User A and User B add non-monetary items for bartering to the barter transaction system 100 (at steps 305 and 310, respectively). In this example, User A adds a first non-monetary item to the barter transaction system 100, and User B adds a second non-monetary item to the barter transaction system 100.

User A then uses the barter transaction system 100 to search for another item for exchange (at step 315). Different embodiments provide different ways to allow the user to search for other barter items. In some embodiments, the barter transaction system 100 allows the user to search by providing key terms of what the user is looking for. The barter management module 115 will then use the key terms to query the barter transaction database, by matching the key terms with the description attributes or the tags attributes of the barter item objects. For example, the user can provide key terms such as “Alex Cross book”, and the barter management module 115 would query the barter transaction database 110 by matching any one of the key terms (or a portion of the key terms or all of the key terms) with the description and/or the tags of the barter item objects in the database 110.

In some embodiments, the barter transaction system 100 allows the user to search by providing a monetary value (in any currency). Once received a monetary value, the barter management module 115 can query the barter transaction database 110 by matching the provided monetary value to values that are assigned to the barter item objects by their respective owners. In some embodiments, the barter management module 115 will normalize the assigned values of the barter item objects so that the assigned values will all be in a single currency. In some embodiments, the barter management module 115 can retrieve barter item objects having assigned values within a range of values including the provided monetary value.

In some other embodiments, the barter transaction system 100 allows the user to initiate a search by identifying an item that the user wants to barter with, and uses characteristics of the item (e.g., the assigned value, the description, tags, etc.) to search for potential items within the database 110 for an exchange. For example, if the user desires to put out a second hand novel by James Patterson entitled “Alex Cross, Run”, with a perceived value of five dollars, the barter transaction engine 105 can search for (1) items with assigned values within a range that includes five dollars (e.g., between two dollars and ten dollars), (2) other novels in the same genre as this novel, and (3) other novels by James Patterson. Instead of putting out one item, the user can also put out more than one items and search for items to exchange with. In this case, the barter transaction engine 105 would calculate the accumulated assigned value and search for items based on the accumulated value.

In some embodiments, User A can also browse the barter items that are available for potential barter transaction through the user interface. For example, the user can browse by users, pre-defined tags, value range, and so forth.

After receiving the searching or browsing criteria from User A, the barter transaction system 100 queries the barter transaction database 110 for a resulting set of barter items. The barter transaction system 100 then present the resulting set of barter items to User A via the user interface (at step 320).

Once User A finds an item that he/she wants (e.g., the second non-monetary item added by User B) within the result set of barter items, User A can initiate a barter request via the user interface (at step 325). When the barter transaction system 100 receives a barter transaction request from User A, the user interface module 125 prompts User A for a trading item that the user would like to barter with (hereinafter referred to as a first non-monetary item). The user interface module 125 also prompts User A for a target item that User A desires to receive in the barter transaction (hereinafter referred to as a second non-monetary item). The barter transaction engine 105 then sends the barter transaction request to the owner of the second non-monetary item, User B (at step 330).

In the barter transaction request, the barter transaction engine 105 also presents to User B the first non-monetary item that User A wants to barter with, and information related to that item, including the description, the condition, the value that User A assigned to the item, and others.

At this point, User B can accept (which leads to an agreement to a barter transaction with the same terms as the ones initiated by User A) or decline the barter transaction request. In addition, User B can further negotiate the barter transaction with User A (at step 335) and offer new terms of the barter exchange. For example, User B can counteroffer by asking User A to add another item(s) to the barter transaction. In addition, User B can request User A to modify/update the assigned value to the trading item if User B believes that the assigned value is too low or too high. The negotiation of the assigned value to the trading item is important because the barter transaction system will use the assigned value to determine a compensation amount for User B in the event that User A fails to fulfill the obligation of a barter transaction with respect to the first non-monetary item (e.g., when User A fails to deliver the first non-monetary item, when the item that User B receives is different from the description and/or condition of the first non-monetary trading item, etc.). Whenever User B puts forth a new offer (e.g., including a new or different term of the transaction), User A can decide to accept (which leads to an agreement to a barter transaction using User B's terms), decline, or provide counter offers (e.g., continue to negotiate with User B, and provide new offer terms). In some embodiments, the facilitation of this negotiation is performed by the compensation negotiation module 120 via the user interface.

The compensation negotiation module 120 allows User A and User B to negotiate back and forth until either one accepts (at steps 340 and 345), or decline, the terms put forth by the other party. Once a party accepts the terms of the other party, the barter transaction system 100 bound User A and User B to a barter transaction agreement that involves at least an exchange of the first non-monetary item from User A and the second non-monetary item from User B.

Instead of allowing User A and User B to negotiate the value assigned to the first non-monetary item, the barter transaction engine 105 of some embodiments prompts User B for a perceived value that User B perceives of the first non-monetary item. The barter transaction engine 105 then determines the compensation amount with respect to the first non-monetary item based on the perceived value from User A and the perceived value from User B. In some embodiments, the compensation amount is a function of the perceived value from User A and the perceived value from User B. Additionally, the barter transaction engine 105 can deny User A and User B from entering into a barter transaction (agreement) if the perceived value of User A deviates from the perceived value of User B by a certain amount or by a certain percentage.

When User A and User B agree on the terms of the barter transaction, they enter into an agreement that represents an obligation of User A to exchange the first non-monetary item for the second non-monetary item. In some embodiments, once User A and User B entered into the agreement, the barter transaction engine 105 automatically determines a compensation amount for each party with respect to an item that the party expects to receive in the barter transaction. The purpose of determining the compensation amounts is to determine an amount of money to compensate a non-breaching party in the transaction in the event that a breaching party in the transaction fails to fulfill his/her obligation with respect to the item. Thus, the party who does not receive an item or receives an item that is different from what is expected in the transaction will be compensated with that amount.

In this example, the barter transaction engine 105 determines that the compensation amount for User A with respect to the second non-monetary item $X, and the compensation amount for User B with respect to the first non-monetary item is $Y. Accordingly, if User B fails to deliver the second non-monetary item to User A (or delivers an item that is different from the second item), User A should be compensated with $X. Similarly, if User A fails to deliver the first non-monetary item to User B (or delivers an item that is different from the first item), User B should be compensated with $Y. The barter transaction engine 105 then presents the compensation amounts to both User A and User B (at step 340).

In some embodiments, the barter transaction engine 105 determines the compensation amount with respect to an item based on the assigned value of the item. In the above example, the compensation amount for User A with respect to the second non-monetary item will be determined based on the value of the second non-monetary item assigned by User B. Similarly, the compensation amount for User B with respect to the first non-monetary item will be determined based on the value of the first non-monetary item assigned by User A.

In some embodiments, the barter transaction system 100 has access to fund accounts (e.g., bank accounts, Paypal® accounts, credit cards, debit cards, etc.) of both User A and User B (not shown in the figure). In some of these embodiments, the barter transaction system 100 can withhold (or instruct an institution to withhold) an amount of money (e.g., the determined compensation amount) from the account of each respective party in the transaction, and transfer the compensation amount to the other party in the transaction if the party fails to fulfill the obligation.

In this example, the barter transaction engine 105 will withhold (or instruct an institution to withhold) $X from User B's account and $Y from User A's account once User A and User B agree to a barter transaction. The barter transaction engine 105 in some embodiments will withhold the amounts of money from both accounts until a certain period of time (e.g., 5 days) lapses without being notified of any dispute. If, within the period of time, it is notified that a breaching party has failed to fulfill his/her obligation in the barter transaction, the barter transaction engine 105 will transfer (or instruct an institution to transfer) the compensation amount of money from the breaching party's account to the non-breaching party's account.

Different embodiments of the invention determine these compensation amounts for the bartering items in different ways. In some embodiments, the compensation amount for an item is the same as the value of the item assigned by its owner. There are many benefits to this approach. One benefit is clarity. Since the assigned value can be presented along with other information of the item, it is clear to a user what kind of “insurance” the user can get if he/she were to exchange for this item. Additionally, since this value is assigned by the owner, it is also clear to the owner of the item his/her financial responsibility if the owner fails to fulfill his/her obligation. The barter transaction engine 105 can also determine the compensation amount with respect to an item as a function of the assigned value of the item. In these embodiments, the compensation amount with respect to an item depends on how both User A and User B perceive the item (through the negotiation process).

It is also contemplated that even though each user assigns his/her own financial responsibility through assigning the perceived value of the bartering items, there is no incentive for the user to understate or overstate the value of the item for several reasons. First, the barter transaction system 100 provides a user interface for users to negotiate the terms of the transaction, including the assigned value of the items involved in the transaction. If the other party (non-assigning party) feels the assigned value to be inadequate, the parties can freely negotiate to an agreeable value or either party can decline to proceed with the transaction. Second, the assigned value is presented along with other information of the item via the user interface. Thus, having an accurate assigned value allows the owner to initiate and receive requests of a desirable exchange. For example, if the owner understated his/her item (e.g., assigning a value of $10 when the item is actually worth $50), the owner will likely receive barter requests to exchange for other items that are close to $10 in value (rather than items that are close to $50 in value).

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A system for facilitating a barter transaction, comprising:
a bartering database storing bartering data associated with a first set of bartering items that belong to a first user and bartering data associated with a second set of bartering items that belong to a second user;
a barter transaction engine coupled to the bartering database and configured to:
receive a barter transaction request comprising an agreement representing an obligation of the first user to exchange a first bartering lot selected from the first set of bartering items for a second bartering lot selected from the second set of bartering items and associated with the second user;
determine a compensation amount that compensates the second user in an event that the first user fails to fulfill the obligation of the barter transaction; and
configuring an output device to present the compensation amount to the first user.

2. The system of claim 1, wherein the compensation amount comprises a currency of a sovereign jurisdiction.

3. The system of claim 1, wherein the compensation amount comprises a currency of a non-sovereign community.

4. The system of claim 3, wherein the non-sovereign community is a virtual community.

5. The system of claim 1, wherein the barter transaction engine is further configured to withhold the compensation amount from a first account owned by the first user.

6. The system of claim 1, wherein the compensation amount is determined based in part of a first perceived value perceived by the first user of the first bartering lot.

7. The system of claim 6, wherein the compensation amount is further based on a second perceived value perceived by the second user of the first bartering lot.

8. The system of claim 7, wherein the compensation amount is a function of the first perceived value and the second perceived value.

9. The system of claim 6, wherein the barter transaction engine is further configured to receive the first perceived value from the first user and store the first perceived value in the database.

10. The system of claim 1, wherein the first bartering lot comprises at least two bartering items from the first set of bartering items.

11. The system of claim 1, wherein the barter transaction engine is further configured to deny the barter transaction request when the first perceived value deviates from the second perceived value by a threshold.

12. The system of claim 1, wherein the first bartering lot comprises a product.

13. The system of claim 1, wherein the first bartering lot comprises a service.

14. The system of claim 1, wherein the barter transaction engine is further configured to allow the first user to update the first perceived value before execution of the barter transaction.

15. The system of claim 1, wherein the barter transaction engine is further configured to query the database for a bartering item with an associated perceived value that is within a predetermined deviation from the first perceived value.

16. The system of claim 15, wherein the barter transaction engine is further configured to configure the output device to present the bartering item to the first user.

17. The system of claim 1, wherein the barter transaction engine is further configured to query the database for a plurality of bartering items with an accumulated perceived value within a predetermined deviation from the first perceived value.

18. The system of claim 1, wherein the barter transaction engine is further configured to provide an interface that allows the first and second users to negotiate the compensation amount.

19. The system of claim 1, wherein the barter transaction engine is further configured to validate the first perceived value.

20. A method for facilitating a barter transaction, comprising:
providing access to a bartering database storing bartering data associated with a first set of bartering items that belong to a first user and bartering data associated with a second set of items that belong to a second user;
providing access to a barter transaction engine communicatively coupled to the bartering database;
receiving, by the barter transaction engine, a barter transaction request comprising an agreement representing an obligation of the first user to exchange a first bartering lot selected from the first set of bartering items for a second bartering lot selected from the second set of bartering items and associated with the second user;
determining, by the barter transaction engine, a compensation amount that compensates the second user in an event that the first user fails to fulfill the obligation of the barter transaction; and
configuring, by the barter transaction engine, an output device to present the compensation amount to the first user.
